(19) United States
(12) Patent Application Publication
(10) Pub. No.: US 2017/0287503 A1
(43) Pub. Date: Oct. 5, 2017

(54) AUDIO TRACKING

(71) Applicant: SpeakWrite, LLC, Austin, TX (US)

(72) Inventor: Richard Jackson, Austin, TX (US)

(73) Assignee: SpeakWrite, LLC, Austin, TX (US)

(21) Appl. No.: 15/479,485

(22) Filed: Apr. 5, 2017

Related U.S. Application Data
(60) Provisional application No. 62/318,453, filed on Apr. 5, 2016.

(51) Int. Cl. G10L 21/10; G06F 17/22; G10L 21/18; G10L 15/26

(52) U.S. Cl. CPC G10L 21/10; G10L 15/26; G06F 17/2235; G10L 21/18

(57) ABSTRACT

A transcription provider is presented with an audio recording created using one or more recording devices. A transcriptionist using proprietary computer software records at discrete intervals both the position of the audio playing for the transcriptionist and the position of the cursor in the document being typed by the transcriptionist, thereby creating both a completely typed document and an audio map. The completed document may be further processed such that each word is matched to its corresponding audio position using the information acquired from the audio map and the matched word may then be put into a separate document as a hyperlink containing meta-data that points to the exact matching audio position. By simultaneously tracking the progress of audio playback and transcriptionist progress within a document, the transcriptionist is then able to display an interactive version of the completed document.

### PRIORITY STATEMENT UNDER 35 U.S.C. §119 & 37 C.F.R. §1.78

This non-provisional application claims priority based upon prior U.S. Provisional Patent Application Ser. No. 62/318,453 filed Apr. 5, 2016 in the name of Richard Jackson, entitled “AUDIO TRACKING” the disclosure of which is incorporated herein in its entirety by reference as if fully set forth herein.

### BACKGROUND

Voice recording systems are commonly used in the art for transcription purposes. Such systems typically record messages from, for example, a microphone in a meeting room or through the telephone, such as a conference bridge. Recorded conversations can then be played back by a transcriptionist. Transcriptions may be required for conversations that take place by participants gathered in a single environment or through some form of multi-party conferencing system, including systems having electronic switches, servers, and/or databases and a plurality of communications end-points.

At times, it may difficult for the transcriptionist to identify some words spoken in the audio and it may be necessary to leave a placeholder to identify that a word or words were unintelligible to the transcriptionist. In systems previously known in the art, a reviewer, typically one of the participants in the conversation, is required to listen to the audio in order to correct or attempt to correct the words that were unintelligible to the transcriptionist. This requires the reviewer to either listen to the entire audio up to the point in question or skipping around the audio until that point is found, which is tedious and time consuming.

There is a need, therefore, for a process in which the transcriptionist is able to provide an interactive reviewing tool that allows the reviewer to jump directly to a specific part of the audio by clicking on the text in question, and further allows the user to fast forward or rewind automatically to the point in the audio corresponding to the identified text.

### SUMMARY OF THE INVENTION

In various embodiments of the present invention, an audio recording created using one or more recording devices is delivered by a client to a transcription provider for transcription. The transcription provider provides the audio recording to a transcriptionist who transcribes the audio recording. Using proprietary computer software, both the position of the audio playing for the transcriptionist and the position of the cursor in the document being typed by the transcriptionist are recorded at discrete intervals. The output of this process is provided to the transcription provider along with the completely typed document and the audio mapping.

The completed document may be further processed such that each word is matched to its corresponding audio position using the information acquired from the audio mapping data. The matched word may then be put into a separate document as a hyperlink containing meta-data that point to the exact matching audio position. By simultaneously tracking the progress of audio playback and transcriptionist progress within a document, the transcriptionist is then able to display an interactive version of the completed document. This interactive version has the ability to play the original audio and highlight the corresponding text.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram depicting audio recording mediums;

FIG. 2 is a block diagram showing one embodiment of a transcription flow chart; and

FIG. 3 is a block diagram showing one embodiment of a document processing flow chart.

### DESCRIPTION OF THE PREFERRED EMBODIMENTS

The present invention is directed to improved methods and systems for, among other things, audio tracking. The configuration and use of the presently preferred embodiments are discussed in detail below. It should be appreciated, however, that the present invention provides many applicable inventive concepts that can be embodied in a wide variety of contexts other than audio tracking. Accordingly, the specific embodiments discussed are merely illustrative of specific ways to make and use the invention, and do not limit the scope of the invention. In addition, the following terms shall have the associated meaning when used herein:

“audio” means and includes information, whether digitized or analog, encoding or representing audio such as, for example, any spoken language or other sounds such as computer generated digital audio;

“audio stream” means and includes any audio data stream, including an audio file containing a recording of a conference from a telephone or mobile device;

“conference bridge” means and includes a system that allows multiples participants to listen and talk to each other over the telephone lines, VOIP, or similar system;

“diarisation” means partitioning an input audio stream into homogeneous segments according to the speaker identity;

“digital transcribing software” means and includes audio player software designed to assist in the transcription of audio files into text;

“electronic communication” means and includes communication between electrical devices (e.g., computers, processors, conference bridges, communications equipment) through direct or indirect signaling;

“mobile device” means any portable handheld computing device, typically having a display screen with touch input and/or a miniature keyboard, that can be communicatively connected to a meeting; and

“transcriptionist” means a person or application that transcribes audio files into text.

On many occasions, and in multiple situations (including conversations, multiple party meetings; interrogations; panel discussions; legal, legislative, or other hearings; etc.) audio is captured and recorded which then must be transcribed by live transcriptionists, by computer-aided voice recognition software, or otherwise, and a written transcription prepared of all speakers and their words spoken during the recorded period.

These situations may take place by participants gathered in a single environment or through some form of multi-party conferencing system, including systems having electronic switches, servers, and/or databases and a plurality of communications end-points, and the embodiments are not limited to use in any particular environment or with any particular type of multi-party conferencing system or configuration of system elements.

By use of various embodiments of the present invention, a transcriptionist or other user is able to provide an interactive reviewing tool that allows the reviewer to jump directly to a specific part of the audio by clicking on the text in question. In other words, it is possible to search any word or find any location in the text document and then, in turn, the system provides the matching location in the audio file. The reviewing tool will fast forward or rewind automatically to the point in the audio corresponding to the clicked text.

It should be appreciated that embodiments of the present invention may have a variety of uses and there are numerous instances in which it may be desirable for a user to jump from a location in a text document to the corresponding location in an audio recording. For example, it may difficult for the transcriptionist to identify some words spoken in the audio and a placeholder is left to identify that a word or words were unintelligible to the transcriptionist. Traditionally, the reviewer would be required to listen to the audio themselves in order to correct or attempt to correct the missed words. This requires either listening to the entire audio up to the point in question or skipping around the audio until that point is found which is tedious and time consuming.

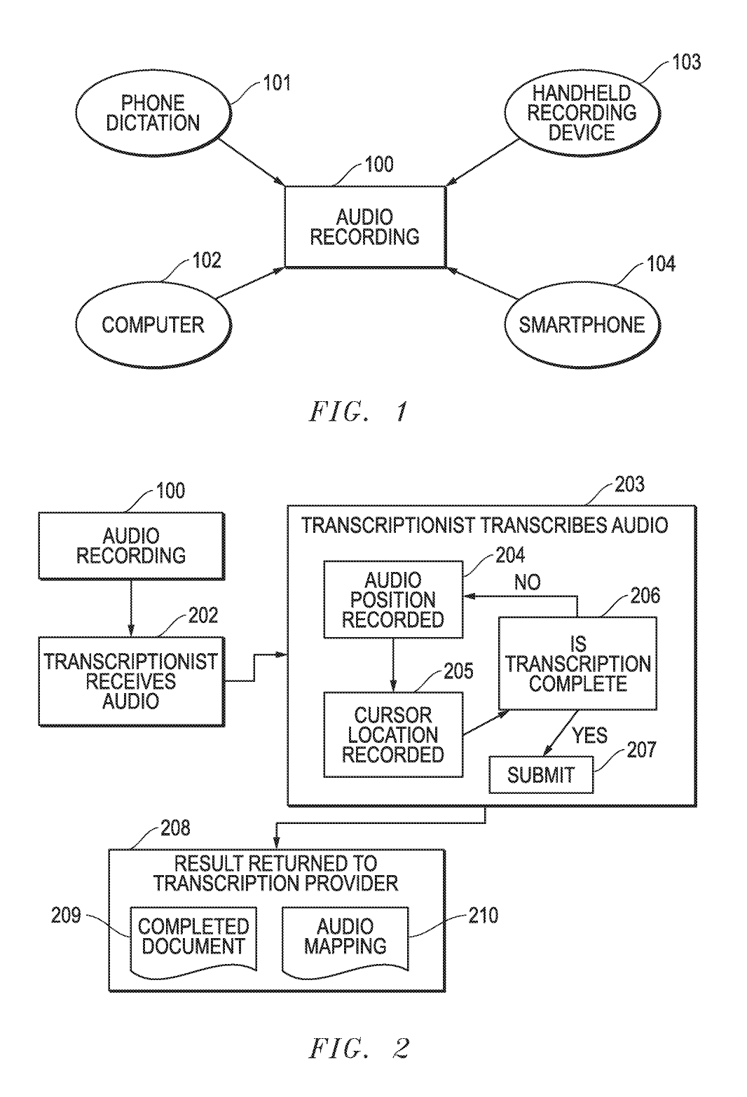

Referring now to FIG. 1 which shows a process by which the audio to be transcribed is recorded in any manner available, with no particular procedure or precautions needed to ensure the successful mapping of audio to transcribed text. The capture of the audio recording 100 may take place through a single audio input device such as a dictating device 101, a computer 102, a handheld recording device 103 or a mobile device 104 or through a plurality of other communicatively-connected audio input devices known in the art. A computer in electronic communication with the audio input devices could be in the same room or in separate rooms, and could receive audio streams from the plurality of audio input devices in real time as they captured audio. In some embodiments, the audio streams may be filtered to reduce noise, to standardize amplitudes or for other reasons known in the art.

Referring now to FIG. 2, wherein the audio recording 100 is delivered by the client to the transcription provider for transcription. The transcription provider provides the audio recording 100 to the transcriptionist 202 and the transcriptionist then transcribes the audio recording 203. Using proprietary digital transcribing software, both the position of the audio playing for the transcriptionist 204 and the position of the cursor in the document being typed by the transcriptionist 205 are recorded at discrete intervals. The transcriptionist continues with the transcription, recording both the audio position 204 and the cursor location 205, until the transcription is complete 206. The output of this process is sent back to the transcription provider 208 along with the completely typed document 209 and the audio mapping 210.

As defined above, the transcriptionist may be any system capable of converting audio into a text representation or copy of the audio. For example, a stenographer listening to spoken language from the audio source and converting the spoken language to text using a stenograph could be considered a transcriptionist for the purposes described herein. Alternatively, a speech-to-text software application and the appropriate hardware to run it could also be considered a transcriptionist.

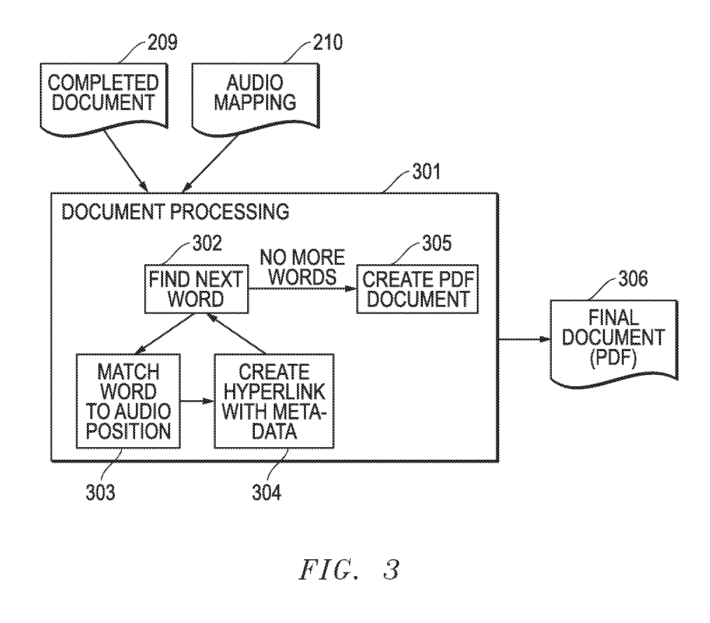

Once the completed document 209 and the audio mapping 210 are returned to the transcription provider, the completed document 209 may be further processed 301 as shown in FIG. 3 to incorporate the audio mapping and create a final document that can be then viewed in a review tool. Iterating through the completed document, each word is matched to its corresponding audio position 303 using the information acquired from the audio mapping data 210. The matched word is then put into a separate document as a hyperlink 304 containing meta-data that point to the exact matching audio position. After each word in the document has completed this process, the resulting final document is saved in final format, such as PDF format 305.

The final document 306 can now be presented to the reviewer in a variety of forms, including through a website or a proprietary viewing tool which allows for the audio to be played while looking at the final document 306. As the audio progresses through the final document 306, a highlighting bar indicates the section of text that corresponds to the audio which is being played. At any point, the audio can be fast-forwarded or rewound and the highlighting bar will move in concert with the audio position. The cursor tracks along the area of text corresponding to the audio being played. The reviewer can also click on the text anywhere in the document and the audio will seek to the corresponding position automatically.

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of transcription methodologies known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

What is claimed is:

1. A method for transcribing audio, comprising:
delivering an audio recording to a transcription provider;
providing the audio recording to a transcriptionist;
transcribing, by the transcriptionist, the audio recording to create a transcription and recording both a position of the audio recording playing for the transcriptionist and a corresponding position of a cursor in the document being transcribed by the transcriptionist at discrete intervals to create an audio map;
providing the transcription and the audio map to the transcription provider; and
using the transcription and the audio map to create a final document in which each word is mapped at its corresponding audio position.

2. The method of claim 1, wherein the transcriptionist is an employee of the transcription provider.

3. The method of claim 1, wherein the transcriptionist is not an employee of the transcription provider.

4. The method of claim 1, wherein the transcriptionist is a stenographer listening to spoken language from the audio recording and converting spoken language to text using a stenograph.

5. The method of claim 1, wherein the transcriptionist is a speech-to-text software application together with hardware required to operate the software.

6. The method of claim 1, wherein after the final document has been created, placing the location of unintelligible words in the final document into a separate document with hyperlinks to the corresponding location in the final document.

7. The method of claim 1, wherein after the final document has been created, placing the location of a plurality of words from the final document into a separate document with hyperlinks to the corresponding location in the final document.

8. The method of claim 1, wherein a viewing tool allows the audio recording to be played while viewing the final document and a highlighting bar indicates the section of text in the final document corresponding to the location in the audio recording.

9. A system for transcribing audio, comprising:
an audio recording provided to a transcriptionist;
software for transcribing audio recordings, wherein the transcriptionist uses the software to transcribe the audio recording to create a transcription and records both a position of the audio recording playing for the transcriptionist and a corresponding position of a cursor in the document being transcribed by the transcriptionist at discrete intervals to create an audio map; and
wherein the transcription and the audio map are used to create a final document in which each word is mapped at its corresponding audio position.

10. The system of claim 9, wherein the transcriptionist is a stenographer listening to spoken language from the audio recording and converting spoken language to text using a stenograph.

11. The system of claim 9, wherein the transcriptionist is a speech-to-text software application together with hardware required to operate the software.

12. The system of claim 9, wherein after the final document has been created, placing the location of unintelligible words in the final document into a separate document with hyperlinks to the corresponding location in the final document.

13. The system of claim 9, wherein after the final document has been created, placing the location of a plurality of words from the final document into a separate document with hyperlinks to the corresponding location in the final document.
